(19) United States
(12) Patent Application Publication
(10) Pub. No.: US 2025/0184706 A1
(43) Pub. Date: Jun. 5, 2025

(54) DISTRIBUTION OF LOCAL WARNING INFORMATION FOR COMMUNICATION DEVICE CONNECTED TO COMMUNICATION STATION

(71) Applicant: RAKUTEN MOBILE, INC., Tokyo (JP)

(72) Inventor: Kenichiro AOYAGI, Tokyo (JP)

(21) Appl. No.: 18/704,037

(22) PCT Filed: Oct. 31, 2023
(86) PCT No.: PCT/JP2023/039197

§ 371 Date: Apr. 23, 2024

(51) Int. Cl. H04W 4/90; H04W 16/26; H04W 64/00; H04W 84/00; H04W 84/06

(52) U.S. Cl. CPC H04W 4/90; H04W 16/26; H04W 64/00; H04W 84/005; H04W 84/06

(57) ABSTRACT

A communication control apparatus includes at least one processor that executes: acquiring, by an emergency information acquirer, emergency information regarding an emergency information distribution area where at least either a communication station capable of communicating with a communication device or the communication device is located; generating, by a local warning information generator, local warning information regarding the emergency information in a vicinity of at least either the communication station or the communication device, the vicinity being smaller than the emergency information distribution area; and distributing, by an information distributor, the local warning information from the communication station to the communication device.

### RELATED APPLICATIONS

The present application is a National Phase of International Application Number PCT/JP2023/039197, filed Oct. 31, 2023.

### TECHNICAL FIELD

The present disclosure relates to distribution of local warning information to a communication device connected to a communication station.

### BACKGROUND ART

The number, types, and applications of radio communication devices (hereinafter, also collectively referred to as communication device) typified by smartphones and Internet of Things (IoT) devices are continuously increasing, and extension and improvement of radio communication standards are continuing. For example, a commercial service of the Fifth Generation Mobile Communication System known as “5G” was started in 2018, but the standards are still being formulated in the Third Generation Partnership Project (3GPP). In addition, efforts have been made to formulate a standard of “6G” or a Sixth Generation Mobile Communication System as a next-generation radio communication standard subsequent to 5G.

### CITATION LIST

### Patent Literature

Patent Literature 1: US 2021/0168643 A

### SUMMARY OF INVENTION

### Technical Problem

In a mobile communication system, an emergency information distribution area is set in which disasters such as earthquakes and tsunamis and other emergency information are simultaneously distributed. Here, since the emergency information distribution area is typically set in units of administrative divisions such as municipalities, only distribution of the summary information common to administrative divisions is allowed.

When only one emergency information distribution area is included in one communication cell, emergency information distribution from the communication cell is easy, but a large communication cell such as a satellite communication cell or a macro cell described later may include a plurality of different emergency information distribution areas. There is a possibility that appropriate emergency information is not distributed to each communication device connected to such a large communication cell, for example, there is a possibility that emergency information regarding an emergency information distribution area different from emergency information distribution area in which the communication device is located is distributed.

The present disclosure has been made in view of such a circumstance and provides a communication control apparatus and the like capable of distributing information highly relevant to a communication device in an emergency.

### Solution to Problem

A communication control apparatus according to an aspect of the present disclosure includes at least one processor that executes: acquiring, by an emergency information acquirer, emergency information regarding an emergency information distribution area where at least either a communication station capable of communicating with a communication device or the communication device is located; generating, by a local warning information generator, local warning information regarding the emergency information in a vicinity of at least either the communication station or the communication device, the vicinity being smaller than the emergency information distribution area; and distributing, by an information distributor, the local warning information from the communication station to the communication device.

According to the present aspect, in an emergency in which emergency information is distributed all at once, local warning information in the vicinity of at least one of the communication station and the communication device is distributed from the communication station to the communication device. The local warning information has a higher degree of relevance for the communication device than the emergency information simultaneously distributed in the emergency information distribution area.

Another aspect of the present disclosure is a communication control method. The communication control method includes executing, by at least one processor: acquisition of emergency information regarding an emergency information distribution area where at least either a communication station capable of communicating with a communication device or the communication device is located; generation of local warning information regarding the emergency information in a vicinity of at least either the communication station or the communication device, the vicinity being smaller than the emergency information distribution area; and distribution of the local warning information from the communication station to the communication device.

Still another aspect of the present disclosure is a storage medium. The storage medium stores a communication control program of causing at least one processor to: acquire emergency information regarding an emergency information distribution area where at least either a communication station capable of communicating with a communication device or the communication device is located; generate local warning information regarding the emergency information in a vicinity of at least either the communication station or the communication device, the vicinity being smaller than the emergency information distribution area; and distribute the local warning information from the communication station to the communication device.

Any combinations of the above constituent elements, and modifications of these expressions into methods, apparatuses, systems, recording media, computer programs, and the like are also included in the present disclosure.

### Advantageous Effects of Invention

The present disclosure makes it possible to distribute information highly relevant to a communication device in an emergency.

### BRIEF DESCRIPTION OF DRAWINGS

FIG. 1 schematically illustrates an outline of a wireless communication system to which a communication control apparatus is applied.

FIG. 2 schematically illustrates an overall configuration of a wireless communication system to which a communication control apparatus is applied.

FIG. 3 is a functional block diagram of a communication control apparatus.

FIG. 4 schematically illustrates an example of processing with a position information acquirer and an emergency information distribution area setter.

### DESCRIPTION OF EMBODIMENTS

Hereinafter, modes for carrying out the present disclosure (hereinafter, also referred to as embodiment) will be described in detail with reference to the drawings. In the description or drawings, the same or equivalent constituent elements, members, processing, and the like are denoted by the same reference numerals, and redundant description is omitted. The scale and shape of each part shown in the drawings are set for the sake of convenience in order to simplify the description, and are not limitedly interpreted unless otherwise specified. The embodiments are exemplary and do not limit the scope of the present disclosure in any way. All features and combinations thereof presented in the embodiments are not necessarily essential to the present disclosure.

For convenience, the embodiments are presented in a decomposed manner into constituent elements for each function or each function group that realize the embodiments. However, one constituent element in the embodiments may be realized in practice by a combination of a plurality of constituent elements as separate bodies, or a plurality of constituent elements in the embodiments may be realized in practice by one constituent element as an integral body. In the description of the wireless communication system in the present embodiment, a term in an existing radio communication standard such as 5G is used for convenience. This is not intended to limit the present disclosure to 5G or the like, and does not preclude application of the present disclosure in a case where a technology similar to the present disclosure is provided with a different name in a future wireless communication system such as 6G.

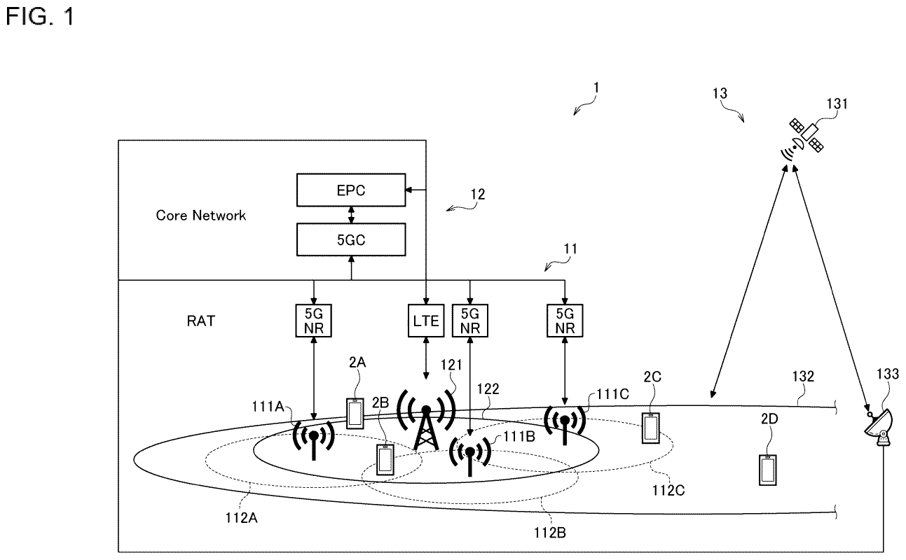

FIG. 1 schematically illustrates an outline of a wireless communication system 1 to which a communication control apparatus according to an embodiment of the present disclosure is applied. The wireless communication system 1 includes a 5G wireless communication system 11, a 4G wireless communication system 12, and a satellite communication system 13. The 5G wireless communication system 11 is compliant with the Fifth Generation Mobile Communication System (5G) that uses New Radio (NR) or the Fifth Generation New Radio (5G NR) as a radio access technology (RAT) and uses the Fifth Generation Core (5GC) as a core network (CN). The 4G wireless communication system 12 is compliant with the fourth Generation Mobile Communication System (4G) that uses Long Term Evolution (LTE) or LTE-Advanced as a radio access technology and uses Evolved Packet Core (EPC) as a core network. The satellite communication system 13 is responsible for satellite communication via a communication satellite 131. Although not illustrated, the wireless communication system 1 may include a wireless communication system of a generation before 4G, may include a wireless communication system of a generation after 5G (6G or the like), or may include any wireless communication system not associated with a generation such as Wi-Fi (registered trademark). The wireless communication system 1 does not have to include some or all of the 5G wireless communication system 11, the 4G wireless communication system 12, and the satellite communication system 13.

The 5G wireless communication system 11 includes a plurality of 5G base stations 111A, 111B, and 111C (hereinafter, also collectively referred to as 5G base station 111) that are installed on the ground and can communicate with communication devices 2A, 2B, 2C, and 2D (hereinafter, also collectively referred to as communication device 2) such as a smartphone also called user equipment (UE) or user terminal (UT) through 5G NR. The base station 111 in 5G is also referred to as gNodeB (gNB). The communicable range or the supported range of each 5G base station 111A, 111B, and 111C is referred to as cell, and the cells are illustrated as 112A, 112B, and 112C (hereinafter, also collectively referred to as 5G cell 112), respectively.

The size of the 5G cell 112 of each 5G base station 111 may be freely determined, but is typically several meters to several tens of kilometers in radius. Although there is no established definition, a cell having a radius of a few meters to tens of meters may be called a femtocell, a cell having a radius of a few meters to tens of meters may be called a picocell, a cell having a radius of a few tens of meters to hundreds of meters may be called a microcell, and a cell having a radius of more than a few hundred meters may be called a macrocell. In 5G, a radio wave having a high frequency such as a millimeter wave is often used, the radio wave is shielded by an obstacle due to high straightness, and a communicable distance is shortened. Thus, in 5G, a small cell tends to be frequently used as compared with 4G or earlier generation.

The communication device 2 can perform 5G communication as long as it is inside at least one of the plurality of 5G cells 112A, 112B, and 112C. In the illustrated example, the communication device 2B in 5G cells 112A and 112B can communicate with both the 5G base stations 111A and 111B through 5G NR. The communication device 2C in the 5G cell 112C can communicate with the 5G base station 111C through 5G NR. Since the communication device 2A and 2D are outside all the 5G cells 112A, 112B, and 112C, communication via 5G NR cannot be performed. 5G communication through 5G NR between each communication device 2 and corresponding 5G base station 111 is managed by 5GC which is a core network. For example, 5GC performs exchange of data with each 5G base station 111, exchange of data with an external network such as EPC, the satellite communication system 13, or the Internet, movement management of the communication device 2, and the like.

The 4G wireless communication system 12 includes a plurality of 4G base stations 121 (only one is illustrated in FIG. 1). The plurality of 4G base stations 121 are installed on the ground and can communicate with the communication device 2 through LTE or LTE-Advanced. The base station 121 in 4G is also referred to as eNodeB (eNB). As with each 5G base station 111, the communicable range or the supported range of each 4G base station 121 is also referred to as cell and is illustrated as 122.

The communication device 2 can perform 4G communication as long as it is inside the 4G cell 122. In the illustrated example, the communication devices 2A and 2B in the 4G cell 122 can communicate with the 4G base station 121 through LTE or LTE-Advanced. Since the communication devices 2C and 2D are outside the 4G cell 122, communication through LTE or LTE-Advanced cannot be performed. 4G communication through LTE or LTE-Advanced between each communication device 2 and corresponding 4G base station 121 is managed by EPC which is a core network. For example, EPC performs exchange of data with each 4G base station 121, exchange of data with an external network such as 5GC, the satellite communication system 13, or the Internet, movement management of the communication device 2, and the like.

Focusing on each of the communication devices 2A, 2B, 2C, and 2D, in the illustrated example, the communication device 2A is in a state capable of 4G communication with the 4G base station 121, the communication device 2B is in a state capable of 5G communication with the 5G base stations 111A and 111B and 4G communication with the 4G base station 121, and the communication device 2C is in a state capable of 5G communication with the 5G base station 111C. When there are a plurality of base stations (111A, 111B, 121) capable of communicating as in the communication device 2B, one base station determined to be optimal from the viewpoint of communication quality and the like is selected, and it communicates with the communication device 2B under the management by 5GC or EPC which is a core network. Since the communication device 2D is not in a state capable of communicating with any of the 5G base stations 111 and the 4G base stations 121, the communication device 2D performs communication with the satellite communication system 13 described below.

The satellite communication system 13 is a wireless communication system that uses, as a non-terrestrial base station, the communication satellite 131 as a low earth orbiting satellite that flies in a low earth orbiting space having a height of about 500 km to 700 km from the ground surface. As with the 5G base station 111 and the 4G base station 121, the communicable range or the supported range of the communication satellite 131 is also referred to as cell and is illustrated as 132. In this manner, the communication satellite 131 as a non-terrestrial base station provides the satellite communication cell 132 as a non-terrestrial communication cell to the ground. The communication device 2 on the ground can perform satellite communication as long as it is inside the satellite communication cell 132. As with the 5G base station 111 in the 5G wireless communication system 11 and the 4G base station 121 in the 4G wireless communication system 12, the communication satellite 131 as a base station in the satellite communication system 13 can wirelessly communicate with the communication device 2 in the satellite communication cell 132 directly or indirectly via an aircraft or the like. The radio access technology used by the communication satellite 131 for radio communication with the communication device 2 in the satellite communication cell 132 may be the same 5G NR as that of the 5G base station 111, may be the same LTE or LTE-Advanced as that of the 4G base station 121, or may be any other radio access technology usable by the communication device 2. Thus, the communication device 2 does not have to be provided with a special function or component for satellite communication.

The satellite communication system 13 includes a gateway 133 as a ground station installed on the ground and capable of communicating with the communication satellite 131. The gateway 133 includes a satellite antenna for communicating with the communication satellite 131 and is connected to the 5G base station 111 or the 4G base station 121 as a terrestrial base station constituting a terrestrial network (TN) via 5G NR, LTE, or other wired or radio access technology or interface that is the radio access technology for each station. In this manner, the gateway 133 intercommunicably connects a non-terrestrial network (NTN) configured by the communication satellite 131 as a non-terrestrial base station or a satellite base station and TN configured by the terrestrial base stations 111 and 121. When the communication satellite 131 performs 5G communication with the communication device 2 in the satellite communication cell 132 through 5G NR, 5GC connected via the gateway 133 and the 5G base station 111 (or a 5G radio access network) in TN is used as a core network. When the communication satellite 131 performs 4G communication with the communication device 2 in the satellite communication cell 132 through LTE or LTE-Advanced, EPC connected via the gateway 133 and the 4G base station 121 (or a 4G radio access network) in TN is used as a core network. In this manner, appropriate cooperation is taken between different wireless communication systems such as 5G communication, 4G communication, and satellite communication via the gateway 133.

The satellite communication with the communication satellite 131 is mainly used to cover an area where a terrestrial base station such as the 5G base station 111 or the 4G base station 121 is not provided or an area where the number of terrestrial base stations is small. In the illustrated example, the communication device 2D outside the communication cells of all the terrestrial base stations communicates with the communication satellite 131. On the other hand, the communication devices 2A, 2B, and 2C in a state of being able to satisfactorily communicate with any one of the terrestrial base stations can also communicate with the communication satellite 131 because they are in the satellite communication cell 132. However, in principle, by communicating with the terrestrial base station instead of the communication satellite 131 as a satellite base station, limited communication resources (including power) of the communication satellite 131 are saved for the communication device 2D and the like. The communication satellite 131 directs communication radio waves to the communication device 2D in the satellite communication cell 132 by beamforming to improve communication quality with the communication device 2D.

The size of the satellite communication cell 132 of the communication satellite 131 as a satellite base station can be freely set according to the number of beams emitted by the communication satellite 131, and for example, the satellite communication cell 132 having a diameter of about 24 km can be formed by combining up to 2,800 beams. As illustrated in the drawings, the satellite communication cell 132 is typically larger than a terrestrial communications cell, such as the 5G cell 112 or the 4G cell 122, and may include one or a plurality of 5G cells 112 or 4G cells 122 therein. In the above description, the communication satellite 131 that flies in a low earth orbiting space at a height of about 500 km to 700 km from the ground surface has been exemplified as a flying non-terrestrial base station. However, a communication satellite that flies in a high earth orbiting space such as a higher geostationary orbit or an unmanned or manned aircraft or a drone that flies in the atmosphere such as the lower (for example, about 20 km from the ground surface) stratosphere may be used as the non-terrestrial base station in addition to or instead of the communication satellite 131.

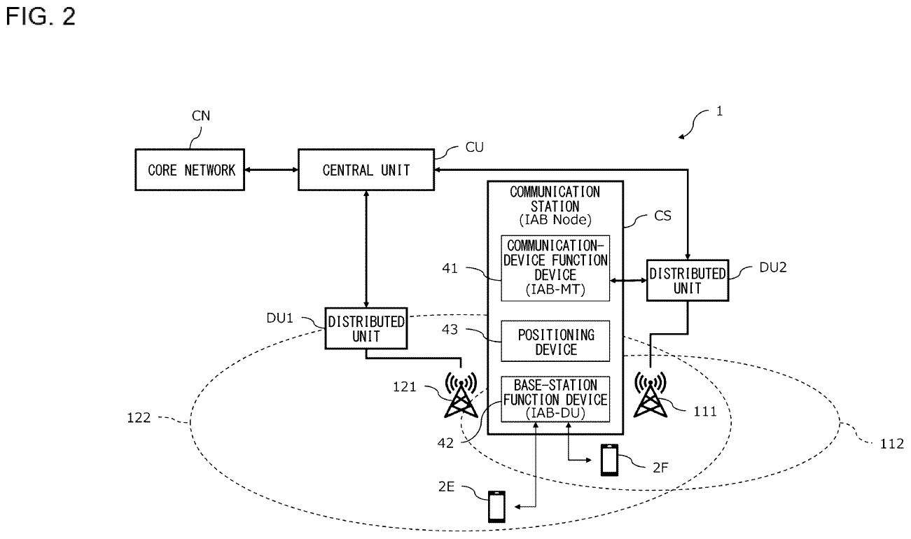

FIG. 2 schematically illustrates an overall configuration of the wireless communication system 1 to which a communication control apparatus according to an embodiment of the present disclosure is applied. As also illustrated in FIG. 1, the wireless communication system 1 is generally constructed by the ground communication cells 112 and 122 (hereinafter, also referred to as fixed base station) provided by the terrestrial base stations 111 and 121 (hereinafter, also referred to as fixed communication cell) fixedly installed on the ground. However, there is an issue that mobile communication cannot be performed outside the fixed communication cell, and even in the fixed communication cell, the quality of mobile communication degrades depending on time and place. The wireless communication system 1 may also include the satellite communication system 13 in which the communication satellite 131 is a non-terrestrial base station or a mobile base station, but it is unrealistic to supplement the terrestrial network of the terrestrial base stations 111 and 121 only with the communication satellite 131.

To solve such an issue, as schematically illustrated in FIG. 2, it is preferable to introduce a communication station CS for supplementing the fixed communication cells 112 and 122 provided by the fixed base stations 111 and 121. The communication station CS can provide the communication device 2 with a static communication cell that does not change spatially or temporally and a dynamic communication cell that can change spatially or temporally. For example, the communication stations CS installed at fixed locations on the ground, such as the terrestrial base stations 111 and 121, provide static communication cells that do not change at least spatially. The moving communication station CS provides a spatially varying (that is, it moves) dynamic communication cell. Further, the communication station switchable between the operating state in which the dynamic communication cell is provided and the stopped state in which the dynamic communication cell is not provided is an example of the communication station CS that provides a dynamic communication cell that changes temporally (that is, ON/OFF switching is performed).

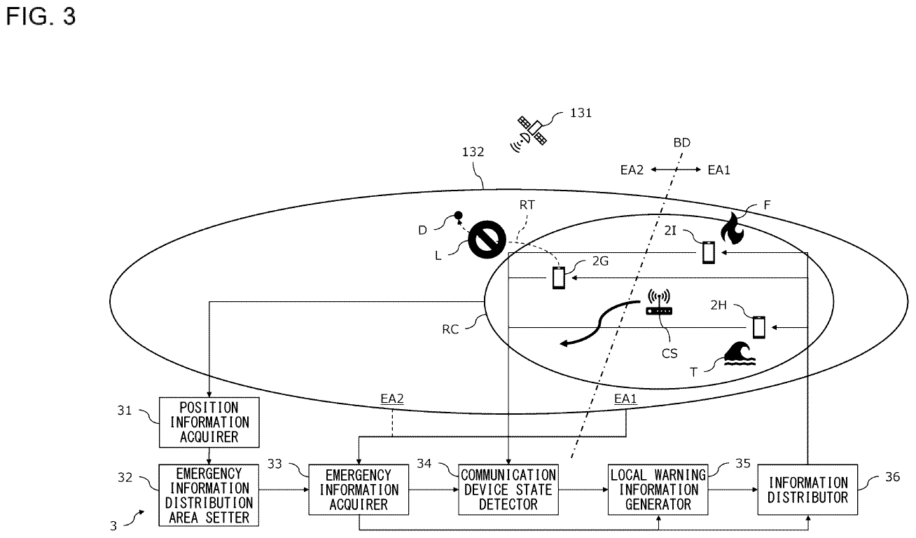

The communication station CS may be, for example, a communication station whose operating time is limited to a specific time zone, or may be an on-demand type communication station that is adaptively switched between a stopped state and an operating state according to a communication demand of a communication device or the like. The communication station CS may be a small base station capable of independently providing a preferably small communication cell such as a femtocell or a picocell without depending on other large base stations such as the terrestrial base stations 111 and 121 and the communication satellite 131, or may be a relay station that communicates with an existing base station or the master base stations 111, 121, and 131 (not illustrated in FIG. 2) to extend the existing communication cell or the master communication cells 112, 122, and 132 (not illustrated in FIG. 2). The communication station CS in the examples of FIG. 2 and FIG. 3 is an integrated access and backhaul (IAB) node or a mobile base station relay (MBSR) that functions as a relay station.

IAB is a technology formulated in 5G, and is a technology for extending a communication cell through a parent node by using a radio backhaul between a base station serving as an IAB donor (parent node) and an IAB node (child node) or between a parent-child IAB node (the IAB node close to the IAB donor becomes the parent node and the IAB node far from the IAB donor becomes the child node). Here, “extension of a communication cell” includes not only extension of an area covered by an existing communication cell but also improvement of communication quality of at least a part of the existing communication cell. Further, “extension of an area covered by a communication cell” includes not only extension of an area of an existing communication cell in a horizontal plane but also extension of the existing communication cell to a vertical direction, for example, an underground or an upper or lower floor of a building.

In FIG. 2, the communication station CS as an IAB node includes a communication-device function device 41 that functions as a communication device for a parent node (parent base station) including the fixed base stations 111 and 121, and a base-station function device 42 that functions as a child base station for the communication device 2 and provides a relay communication cell. In 5G, the communication-device function device 41 is defined as a mobile termination (MT) or an IAB-MT, and the base-station function device 42 is defined as a distributed unit (DU) or an IAB-DU. In other wireless communication systems including a generation after 5G, including a central unit (CU) to be described later, it is also assumed that functions similar to IAB, MT, DU, and CU are provided under different names. However, in the present embodiment, such similar functions may be used as IAB, MT, DU, and CU.

FIG. 2 illustrates two fixed base stations 111 and 121. The first fixed base station 121 as a 4G base station provides a first fixed communication cell 122 as a 4G cell, and the second fixed base station 111 as a 5G base station provides a second fixed communication cell 112 as a 5G cell. In the example of FIG. 2, the baseband function of each of the fixed base stations 111 and 121 is divided into a central unit (CU) on the core network CN side and a distributed unit (DU) on the communication device 2 side. The first distributed unit DU1 of the first fixed base station 121 is provided near a radio apparatus such as an antenna of the first fixed base station 121, typically in the same base station facility as that of the radio apparatus. The second distributed unit DU2 of the second fixed base station 111 is provided near a radio apparatus such as an antenna of the second fixed base station 111, typically in the same base station facility as that of the radio apparatus. The central unit CU in the illustrated example is shared by the first fixed base station 121 (the first distributed unit DU1) and the second fixed base station 111 (the second distributed unit DU2), but a central unit may be individually provided for each of the fixed base stations 111 and 121. The central unit CU is connected to the core network CN. The connection between the radio apparatus such as the antenna in each of the fixed base stations 111 and 121 and the distributed units DU1 and DU2, the connection between each of the distributed units DU1 and DU2 and the central unit CU, and the connection between the central unit CU and the core network CN are typically wired with a conductive wire, an optical fiber, or the like, but some or all of the connections may be wireless.

The communication-device function device 41 (IAB-MT) of the communication station CS can be wirelessly connected to the distributed unit DU of any of the fixed base stations 111 and 121 according to the location of the communication station CS. In the example of FIG. 2, the communication-device function device 41 is wirelessly connected to the second distributed unit DU2 of the second fixed base station 111. The communication station CS in this case functions as a child node having the second fixed base station 111 as a parent node (parent base station) or an IAB donor, and extends the second fixed communication cell 112 with the second fixed base station 111 as a parent node. Then, the base-station function device 42 (IAB-DU) of the communication station CS provides the communication device 2 with a relay communication cell (not illustrated) as an extended communication cell of the second fixed communication cell 112. In the example of FIG. 2, two communication devices 2E and 2F connected to the base-station function device 42 of the communication station CS are schematically illustrated. The first communication device 2E substantially communicates with the second fixed base station 111 through the communication station CS while being inside the first fixed communication cell 122 and outside the second fixed communication cell 112. The second communication device 2F substantially communicates with the second fixed base station 111 through the communication station CS while being within the overlapping area of the first fixed communication cell 122 and the second fixed communication cell 112. The communication station CS as an IAB node may extend a mobile communication cell or a non-terrestrial communication cell such as the satellite communication cell 132 by using a mobile base station or a non-terrestrial base station such as the communication satellite 131 as a parent base station, as described later with reference to FIG. 3.

The communication station CS of movable type is attached to a mobile object except for a case where the communication station CS can move or fly autonomously like the communication satellite 131. The mobile object is any movable object or person, and includes, for example, any rides such as an automobile, a train, a motorcycle, a bicycle, an airplane, a drone, or a ship. The moving communication station CS may be a communication device 2 carried by a moving person, for example, the communication device 2 having a tethering function or a personal hotspot function. Since such a communication device 2 (communication station CS) generally functions as a wireless LAN access point, the RAT (for example, 5G NR) used by the extension source base station (for example, the second fixed base station 111) and the RAT used by the extension destination communication station CS may be different.

In addition to the communication-device function device 41 and the base-station function device 42, the communication station CS may include a positioning device 43 capable of positioning the communication station CS itself or the communication device 2 being connected.

The positioning device 43 may be a satellite positioning device such as a GPS module that acquires position information of the communication station CS itself based on a satellite positioning system such as a GPS or a global navigation satellite system (GNSS). For example, the positioning device 43 such as a GPS module may receive satellite positioning radio waves from a plurality of positioning satellites (not illustrated) constituting the satellite positioning system, and calculate the position information of the communication station CS based on each transmission time or the like.

The positioning device 43 may estimate the position information of the communication device 2 based on communication between the communication station CS (base-station function device 42) and the communication device 2. For example, the time or delay required for communication between the communication station CS and the communication device 2 suggests a distance between the communication station CS and the communication device 2. When the communication station CS has a function such as beamforming, the direction of the antenna of the communication station CS communicating with the communication device 2 and the transmission direction or the reception direction of the beam suggest the direction in which the communication device 2 is present with respect to the communication station CS. Based on such a relative distance and direction of the communication device 2 with respect to the communication station CS, the positioning device 43 can estimate the position information of the communication device 2.

The positioning device 43 may acquire the position information of the communication device 2 through a positioning electromagnetic wave emitted from one of the communication station CS and the communication device 2 to the other. For example, the communication station CS preferably emits, to the communication device 2, a positioning radio wave or positioning light having a wavelength or frequency different from that of the communication radio wave. The communication device 2 may notify the positioning device 43 of the time and intensity at which the positioning electromagnetic wave is received through communication with the base-station function device 42. The positioning device 43 can calculate the position information of the communication device 2 based on the transmission time, the transmission intensity, the transmission direction, and the like of the positioning electromagnetic wave in the positioning device 43 in addition to the reception time and the reception intensity of the positioning electromagnetic wave in the communication device 2. Instead of or in addition to the electromagnetic wave, any physical phenomenon capable of non-contact distance measurement, such as sound, vibration, or wave, may be used to acquire the relative position information of the communication device 2 with respect to the communication station CS.

FIG. 3 is a functional block diagram of a communication control apparatus 3 according the present embodiment. The communication control apparatus 3 includes a position information acquirer 31, an emergency information distribution area setter 32, an emergency information acquirer 33, a communication device state detector 34, a local warning information generator 35, and an information distributor 36. Some of these functional blocks may be omitted as long as the communication control apparatus 3 can realize at least some of the functions or effects described below. These functional blocks are realized by cooperation of hardware resources such as a central processor, a memory, an input apparatus, and an output apparatus of a computer, and a peripheral device connected to the computer, and software executed using the hardware resources. Regardless of the type and installation location of the computer, each functional block described above may be realized by hardware resources of a single computer, or may be realized by combining hardware resources distributed to a plurality of computers. In particular, in the present embodiment, some or all of the functional blocks of the communication control apparatus 3 are preferably realized by the core network CN, but may be realized in a centralized or distributed manner by a base station (distributed unit DU or central unit CU) such as the communication satellite 131, the gateway 133, the communication station CS, or a computer or a processor provided in the communication device 2.

In the example of FIG. 3, the communication satellite 131 as a base station and the communication devices 2G, 2H, and 2I (hereinafter, also collectively referred to as communication device 2) can communicate via the communication station CS as an IAB node or a relay station. As described above with reference to FIG. 2, the communication station CS provides the communication device 2 with the relay communication cell RC as an extended communication cell of the satellite communication cell 132 provided by the communication satellite 131 through the communication-device function device 41 that functions as a communication device with respect to the communication satellite 131 as a parent base station and the base-station function device 42 that functions as a child base station with respect to the communication device 2. The base station is not limited to the communication satellite 131, and may be terrestrial base stations 111 and 121 capable of providing preferably large communication cells such as a macrocell.

In the wireless communication system 1, an emergency information distribution area is set in which disasters such as earthquakes and tsunamis and other emergency information are simultaneously distributed. A system that distributes emergency information is also called a public warning system (PWS), and in particular, a system that distributes a warning regarding a disaster such as an earthquake or tsunami is also called an earthquake and tsunami warning system (ETWS). The emergency information distribution area is generally set in units of administrative divisions such as municipalities, and the fixed base stations 111 and 121 fixedly installed on the ground as illustrated in FIG. 2 belong to the emergency information distribution areas set in the administrative divisions of the places where they are installed.

On the other hand, as schematically illustrated in FIG. 3, a large communication cell such as the satellite communication cell 132 or a macrocell (not illustrated) provided by the communication satellite 131 may include a plurality of different emergency information distribution areas. In the example of FIG. 3, the satellite communication cell 132 provided by the communication satellite 131 includes two different emergency information distribution areas EA1 and EA2. The boundary line BD is a boundary line between the emergency information distribution areas EA1 and EA2. In the illustrated state, the communication station CS and the communication devices 2H and 2I belong to or is located in the first emergency information distribution area EA1 set in the first administrative division, and the communication device 2G belongs to or is located in the second emergency information distribution area EA2 set in the second administrative division.

The emergency information distribution system that may constitute a part of the information distributor 36 to be described later distributes emergency information to all the communication devices 2 in the emergency information distribution area in which a disaster or the like has occurred all at once. Specifically, when a disaster or the like has occurred in the first emergency information distribution area EA1, the communication stations CS belonging to the first emergency information distribution area EA1 simultaneously distribute emergency information to at least the communication devices 2H and 2I in the first emergency information distribution area EA1. Since the communication device 2G is outside the first emergency information distribution area EA1 but is connected to the communication station CS belonging to the first emergency information distribution area EA1, the communication device 2G may receive emergency information regarding the first emergency information distribution area EA1 similarly to the communication devices 2H and 2I.

Alternatively, the communication device 2G may receive emergency information regarding the second emergency information distribution area EA2 in which the communication device 2G is actually located even when the communication device 2G is connected to the communication station CS belonging to the first emergency information distribution area EA1. In this case, the fact that the communication device 2G is located in the second emergency information distribution area EA2 is recognized by, for example, the core network CN (not illustrated) that has acquired the position information through a satellite positioning device such as a GPS module of the communication device 2G itself. Then, the core network CN distributes the emergency information regarding the second emergency information distribution area EA2 to the communication device 2G located in the second emergency information distribution area EA2 to the communication station CS belonging to the first emergency information distribution area EA1.

The position information acquirer 31 preferably provided in the core network CN acquires the communication station CS capable of communicating with the communication device 2 or the position information of the communication device 2. As described above, when the positioning device 43 of the communication station CS includes a satellite positioning device such as a GPS module, the satellite positioning information (that is, the position information of the communication station CS) may be provided to the core network CN via the communication satellite 131. In the same manner, when the communication device 2 includes a satellite positioning device such as a GPS module, the satellite positioning information (that is, the position information of the communication device 2) may be provided to the core network CN via the communication satellite 131.

The emergency information distribution area setter 32 sets an emergency information distribution area for the communication station CS or the communication device 2 based on the position information of the communication station CS or the communication device 2 acquired by the position information acquirer 31. In the illustrated example, the emergency information distribution area setter 32 may set the first emergency information distribution area EA1 to the communication station CS according to the position information of the communication station CS acquired by the position information acquirer 31 indicating the location in the first emergency information distribution area EA1.

Alternatively, the emergency information distribution area setter 32 may set the first emergency information distribution area EA1 in an area on one side (right side in FIG. 3) of the boundary line BD in the relay communication cell RC and set the second emergency information distribution area EA2 in an area on the other side (left side in FIG. 3) of the boundary line BD in the relay communication cell RC based on the position information of the communication station CS acquired by the position information acquirer 31, the disposition information of the boundary line BD, the range information of the relay communication cell RC, and the like. In this case, the emergency information distribution system that may constitute a part of the information distributor 36 to be described later can distribute the emergency information regarding the first emergency information distribution area EA1 from the communication station CS to the communication devices 2H and 2I in the first emergency information distribution area EA1, and can distribute the emergency information regarding the second emergency information distribution area EA2 from the communication station CS to the communication device 2G in the second emergency information distribution area EA2.

Similarly, the emergency information distribution area setter 32 may set the first emergency information distribution area EA1 in the communication devices 2H and 2I according to the position information of the communication devices 2H and 2I acquired by the position information acquirer 31 indicating the location in the first emergency information distribution area EA1, or may set the second emergency information distribution area EA2 in the communication device 2G according to the position information of the communication device 2G acquired by the position information acquirer 31 indicating the location in the second emergency information distribution area EA2.

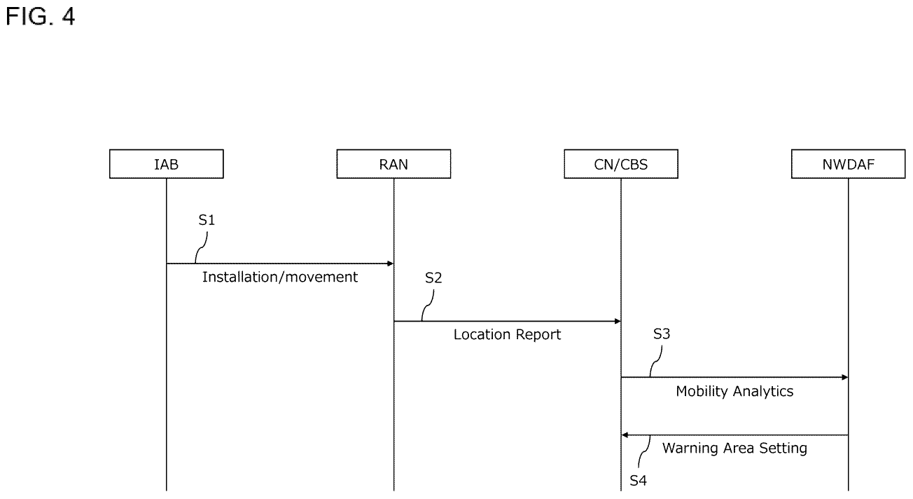

FIG. 4 schematically illustrates an example of processing with the position information acquirer 31 and the emergency information distribution area setter 32. In the drawing, time flows from top to bottom. In this example, various pieces of data are sequentially exchanged among “IAB” such as the communication station CS, “RAN” (Radio Access Network) such as the communication satellite 131, “CN/CBS” such as the core network CN or a Cell Broadcast Service (CBS) provided by the core network CN, and “NWDAF” such as a network data analytics function (NWDAF) which may be a part of the core network CN. In the drawing, “S” means a step or processing.

In S1, “IAB” transmits the position information of the communication station CS to the “RAN” at the time of installation of a new communication station CS, movement of the communication station CS as schematically illustrated by an arrow in FIG. 3, or transition of the emergency information distribution area (in the movement example of FIG. 3, transition from the first emergency information distribution area EA1 to the second emergency information distribution area EA2) associated with the movement under the position information acquirer 31. In this manner, the communication station CS may be movable over different emergency information distribution areas EA1 and EA2.

In S2, the position information of the communication station CS transmitted to “RAN” in S1 is transmitted to “CN/CBS” by “RAN” in the form of a location report under the position information acquirer 31. The position information of the communication station CS acquired by “CN/CBS” constituting the position information acquirer 31 through S1 and S2 may be measured by the positioning device 43 of the communication station CS such as a GPS module as described above, or may be estimated or measured through a communication radio wave or a positioning electromagnetic wave emitted from the communication satellite 131 or the like as “RAN” to the communication station CS as “IAB”.

In S3, under the emergency information distribution area setter 32, the “CN/CBS” requests the “NWDAF” to perform mobility analytics of the communication station CS based on the position information of the communication station CS acquired in S2. In S4, the “NWDAF” executes the mobility analytics of the communication station CS in response to the request in S3 under the emergency information distribution area setter 32, and provides the “CN/CBS” with the emergency information distribution area (warning area) of the communication station CS at the current or future time set based on the result.

Here, the “NWDAF” may be an artificial intelligence (AI)/machine learning (ML) function in the core network CN, and the emergency information distribution area in which the communication station CS is located at each time of the present or future may be specified through comprehensive analysis of the current or past position information or movement information of the communication station CS acquired in S2 and various other available related information (for example, disposition information of the boundary line BD and range information of the relay communication cell RC).

In this manner, the emergency information distribution area setter 32 can be configured by various AI/ML functions in the core network CN such as NWDAF introduced in 5GC. NWDAF is responsible for collecting and analyzing data on a network such as a 5G network. Specifically, NWDAF collects and accumulates activity history information, movement information, measurement information, and the like of the communication station CS and the communication device 2 connected to the mobile communication network, and utilizes analysis results thereof for traffic control and the like on the mobile communication network. The function of analyzing the movement information of the communication station CS and the communication device 2 provided by NWDAF is also referred to as mobility analytics as described above. In other wireless communication systems including a wireless communication system of a generation after 5G, it is assumed that a function similar to that of NWDAF is provided with a different name, but in the present embodiment, such a similar function may be used instead of or in addition to NWDAF.

In FIG. 3, the emergency information acquirer 33 acquires the emergency information regarding the emergency information distribution area in which the communication station CS or the communication device 2 are located. For example, the emergency information acquirer 33 may acquire the emergency information regarding the emergency information distribution area set by the emergency information distribution area setter 32 (S3 and S4 in FIG. 4) based on the position information of the communication station CS acquired by the position information acquirer 31 (S1 and S2 in FIG. 4). The emergency information acquirer 33 may acquire the emergency information regarding the emergency information distribution area set by the emergency information distribution area setter 32 based on the position information of each communication device 2 acquired by the position information acquirer 31.

In the example of FIG. 3, when the emergency information distribution area setter 32 sets the first emergency information distribution area EA1 in which the communication station CS is located with respect to the communication station CS, the emergency information acquirer 33 may acquire only the emergency information regarding the first emergency information distribution area EA1. On the other hand, when the emergency information distribution area setter 32 sets the first emergency information distribution area EA1 with respect to the communication devices 2H and 2I in the first emergency information distribution area EA1 and sets the second emergency information distribution area EA2 with respect to the communication device 2G in the second emergency information distribution area EA2, the emergency information acquirer 33 may acquire the emergency information regarding both the emergency information distribution areas EA1 and EA2. In any case, the emergency information acquired by the emergency information acquirer 33 remains in summary information (“earthquake with a seismic intensity X occurs in M minutes at H hour in B city in A prefecture” or the like) common to emergency information distribution areas generally set in units of administrative divisions such as municipalities.

In the present embodiment, local warning information regarding emergency information having high relevance for each communication device 2 in the relay communication cell RC is distributed in addition to or instead of the emergency information remaining in the summary information in units of administrative divisions. Here, the local warning information is advisory information regarding a local area substantially centered on the communication station CS or each communication device 2 and smaller than each of the emergency information distribution areas EA1 and EA2 or the satellite communication cell 132 in FIG. 3. Although details will be described later, when the emergency information acquired by the emergency information acquirer 33 is to notify the occurrence of an earthquake, the local warning information may notify a specific communication device 2G in the relay communication cell RC of a landslide L that has occurred in a specific local area in association with the earthquake, may notify a specific communication device 2H in the relay communication cell RC of a tsunami T that has occurred in a specific local area in association with the earthquake, or may notify a specific communication device 2I in the relay communication cell RC of a fire F that has occurred in a specific local area in association with the earthquake.

To provide each communication device 2 with local warning information having a higher degree of relevance, the communication device state detector 34 may detect the status of each communication device 2 in the relay communication cell RC. To enable more accurate state detection, the communication device state detector 34 may be configured by an AI/ML function such as NWDAF that can access and analyze enormous data regarding the current or past situation of each communication device 2.

In the first example of FIG. 3, the communication device state detector 34 detects that the communication device 2G in the relay communication cell RC and the second emergency information distribution area EA2 is moving along a route RT. The route RT may be set with a map application or a route search application of the communication device 2G, may be set with a navigation apparatus of a vehicle on which a user of the communication device 2G rides, or may be estimated from position information or movement information (obtainable from a GPS module or the like) of the communication device 2G and the vehicle and known disposition information of main roads. Further, the communication device state detector 34 detects that the road on the route RT is inaccessible due to the landslide L caused by the earthquake related to the emergency information. The place where the landslide L has occurred may be outside the relay communication cell RC where the communication device 2G is currently located, outside the satellite communication cell 132, or outside the second emergency information distribution area EA2.

In the second example of FIG. 3, the communication device state detector 34 detects that the communication device 2H in the relay communication cell RC and the first emergency information distribution area EA1 is near the sea where the tsunami T is occurring due to the earthquake related to the emergency information. In the third example of FIG. 3, the communication device state detector 34 detects that the communication device 2I in the relay communication cell RC and the first emergency information distribution area EA1 is near a building where the fire F is occurring due to the earthquake related to the emergency information.

The local warning information generator 35 generates local warning information regarding the emergency information acquired by the emergency information acquirer 33 in the vicinity of the communication station CS or the communication device 2 smaller than each of the emergency information distribution areas EA1 and EA2. To enable generation of local warning information highly relevant to each communication device 2, the local warning information generator 35 may be configured by an AI/ML function such as NWDAF capable of accessing and analyzing enormous data regarding the current or past situation of each communication device 2 or the communication station CS.

The “vicinity” of the communication station CS or the communication device 2 for which the local warning information generator 35 generates the local warning information is substantially synonymous with the “local area” described above, and is an area substantially centered on the communication station CS or the communication device 2, and is an area smaller than each of the emergency information distribution areas EA1 and EA2 or the satellite communication cell 132 in FIG. 3. For example, the vicinity of the communication station CS may be in the same range as that of the relay communication cell RC or may be in a range smaller than that of the relay communication cell RC, but is preferably in a range larger than that of the relay communication cell RC so as to be able to distribute local warning information regarding the landslide L outside the relay communication cell RC to the communication device 2G.

In the same manner, the vicinity of each communication device 2 does not necessarily have to be within the range of the relay communication cell RC, and may be set to spread outside the relay communication cell RC. In particular, it is preferable that the vicinity of the communication device 2G for which attention needs to be called regarding the landslide L outside the relay communication cell RC is set to include the site of the landslide L spread outside the relay communication cell RC or a set destination D of the communication device 2G. In this manner, the local warning information generator 35 that may be configured by the AI/ML function such as NWDAF can set the “vicinity” or the “local area” having the optimum size for each of the communication devices 2 or the communication station CS by comprehensively considering the situation of each of the communication devices 2 or the communication station CS and the occurrence situation of a secondary disaster (landslide L, tsunami T, and fire F in FIG. 3) or the like in which attention needs to be called.

The local warning information generator 35 may generate local warning information for each communication device 2 based on the state of each communication device 2 detected by the communication device state detector 34. In the first example of FIG. 3, the local warning information generator 35 generates local warning information for calling attention to occurrence of the landslide L on the route RT and impossibility of passage of a road to the communication device 2G moving along the route RT toward the destination D. The local warning information may suggest a recommended detour route to the communication device 2G.

In the second example of FIG. 3, the local warning information generator 35 generates local warning information for calling attention to the communication device 2H near the sea where the tsunami T is occurring. The local warning information may prompt the user of the communication device 2H to leave the sea immediately, or may suggest a recommended evacuation route to the communication device 2H. In the third example of FIG. 3, the local warning information generator 35 generates local warning information for calling attention to the communication device 2I near the building where the fire F is occurring. The local warning information may prompt the user of the communication device 2I to leave the building immediately, or may suggest a recommended evacuation route to the communication device 2I.

In the above three examples, the local warning information generator 35 generates individual local warning information for each communication device 2, but it may generate common local warning information for a plurality or all of the communication devices 2G, 2H, and 2I in the relay communication cell RC. Even in such a case, local warning information having a higher degree of relevance for each communication device 2 than the emergency information acquired by the emergency information acquirer 33 remaining in the summary information in units of administrative divisions is generated. That is, while the emergency information acquired by the emergency information acquirer 33 is targeted at a large number of communication devices 2 (not illustrated) included in the emergency information distribution areas EA1 and EA2, the local warning information generated by the local warning information generator 35 is specific for a small number of communication devices 2 included in the relay communication cell RC smaller or narrower than the emergency information distribution areas EA1 and EA2.

The information distributor 36 distributes the local warning information generated by the local warning information generator 35 from the communication station CS to each communication device 2 in the relay communication cell RC. In addition to the local warning information, the information distributor 36 may distribute the emergency information acquired by the emergency information acquirer 33 from the communication station CS to each communication device 2 in the relay communication cell RC.

In the first example of FIG. 3, the information distributor 36 may distribute, from the communication station CS to the communication device 2G moving along the route RT toward the destination D, local warning information related to the landslide L occurring on the route RT together with emergency information related to the second emergency information distribution area EA2 in which the communication device 2G is currently located. In the second example of FIG. 3, the information distributor 36 may distribute local warning information regarding the tsunami T occurring in the sea from the communication station CS to the communication device 2H near the sea together with the emergency information regarding the first emergency information distribution area EA1 in which the communication device 2H is currently located. In the third example of FIG. 3, the information distributor 36 may distribute local warning information regarding the fire F occurring in a building from the communication station CS to the communication device 2I near the building together with the emergency information regarding the first emergency information distribution area EA1 in which the communication device 2I is currently located. In this manner, the information distributor 36 may distribute different pieces of local warning information or emergency information from the communication station CS to the plurality of communication devices 2G, 2H, and 2I having different states detected by the communication device state detector 34.

According to the present embodiment, in an emergency in which emergency information is distributed all at once, local warning information in the vicinity of at least one of the communication station CS and the communication device 2 is distributed from the communication station CS to the communication device 2. The local warning information has a higher degree of relevance for the communication device 2 than the emergency information simultaneously distributed in the emergency information distribution areas EA1 and EA2.

The present disclosure has been described above based on the embodiments. Various modifications can be made to combinations of constituent elements and processing in exemplary embodiments, and it is obvious to those skilled in the art that such modifications are included in the scope of the present disclosure.

The configuration, operation, and function of each apparatus and each method described in the embodiments can be realized by hardware resources or software resources, or by cooperation of hardware resources and software resources. As the hardware resources, for example, a processor, a ROM, a RAM, and various integrated circuits can be used. As the software resource, for example, a program such as an operating system or an application can be used.

The present disclosure may be expressed as the following items.

### Item 1:

A communication control apparatus including at least one processor that executes:
acquiring, by an emergency information acquirer, emergency information regarding an emergency information distribution area where a communication station capable of communicating with a communication device is located;
generating, by a local warning information generator, local warning information regarding the emergency information in a vicinity of the communication station, the vicinity being smaller than the emergency information distribution area; and
distributing, by an information distributor, the local warning information from the communication station to the communication device.

### Item 2:

The communication control apparatus according to item 1, wherein the information distributor distributes the emergency information and the local warning information from the communication station to the communication device.

### Item 3:

The communication control apparatus according to item 1 or 2, wherein
the at least one processor executes, by a communication device state detector, detection of a state of the communication device, and
the local warning information generator generates the local warning information based on the state of the communication device.

### Item 4:

The communication control apparatus according to item 3, wherein the information distributor distributes different pieces of the local warning information from the communication station to a plurality of the communication devices in different states.

### Item 5:

The communication control apparatus according to any one of items 1 to 4, wherein the local warning information generator is configured by a network data analytics function (NWDAF).

### Item 6:

The communication control apparatus according to any one of items 1 to 5, wherein the communication station is movable.

### Item 7:

The communication control apparatus according to item 6, wherein the communication station is movable across different emergency information distribution areas.

### Item 8:

The communication control apparatus according to any one of items 1 to 7, wherein
the at least one processor executes, by a position information acquirer, acquisition of position information of the communication station, and
the emergency information acquirer identifies, based on the position information, the emergency information distribution area where the communication station is located.

### Item 9:

The communication control apparatus according to item 8, wherein the position information acquirer acquires position information of the communication station through a satellite positioning device included in the communication station.

### Item 10:

The communication control apparatus according to any one of items 1 to 9, wherein the communication station is a relay station that relays communication between a base station and the communication device.

### Item 11:

The communication control apparatus according to item 10, wherein the relay station is an integrated access and backhaul (IAB) node including a mobile termination (MT) that functions as a communication device with respect to the base station and a distributed unit (DU) that functions as a base station with respect to the communication device.

### Item 12:

The communication control apparatus according to item 10 or 11, wherein the base station is a non-terrestrial base station that flies.

### Item 13:

The communication control apparatus according to item 12, wherein the non-terrestrial base station is a communication satellite that flies in space.

### Item 14:

A communication control method including executing, by at least one processor:
acquisition of emergency information regarding an emergency information distribution area where a communication station capable of communicating with a communication device is located;
generation of local warning information regarding the emergency information in a vicinity of the communication station, the vicinity being smaller than the emergency information distribution area; and
distribution of the local warning information from the communication station to the communication device.

### Item 15:

A storage medium that stores a communication control program of causing at least one processor to execute:
acquisition of emergency information regarding an emergency information distribution area where a communication station capable of communicating with a communication device is located;
generation of local warning information regarding the emergency information in a vicinity of the communication station, the vicinity being smaller than the emergency information distribution area; and
distribute the local warning information from the communication station to the communication device.

### INDUSTRIAL APPLICABILITY

The present disclosure relates to distribution of local warning information to a communication device connected to a communication station.

1. A communication control apparatus comprising at least one processor that executes:
acquiring, by an emergency information acquirer, emergency information regarding an emergency information distribution area where at least either a communication station capable of communicating with a communication device or the communication device is located;
generating, by a local warning information generator, local warning information regarding the emergency information in a vicinity of at least either the communication station or the communication device, the vicinity being smaller than the emergency information distribution area; and
distributing, by an information distributor, the local warning information from the communication station to the communication device.

2. The communication control apparatus according to claim 1, wherein the information distributor distributes the emergency information and the local warning information from the communication station to the communication device.

3. The communication control apparatus according to claim 1, wherein
the at least one processor executes, by a communication device state detector, detection of a state of the communication device, and
the local warning information generator generates the local warning information based on the state of the communication device.

4. The communication control apparatus according to claim 3, wherein the information distributor distributes different pieces of the local warning information from the communication station to a plurality of the communication devices in different states.

5. The communication control apparatus according to claim 1, wherein the local warning information generator is configured by a network data analytics function (NWDAF).

6. The communication control apparatus according to claim 1, wherein the communication station is movable.

7. The communication control apparatus according to claim 6, wherein the communication station is movable across different emergency information distribution areas.

8. The communication control apparatus according to claim 1, wherein
the at least one processor executes, by a position information acquirer, acquisition of position information of at least either the communication station or the communication device, and
the emergency information acquirer identifies, based on the position information, the emergency information distribution area where at least either the communication station or the communication device is located.

9. The communication control apparatus according to claim 8, wherein the position information acquirer acquires position information of at least either the communication station or the communication device through a satellite positioning device included in the at least either the communication station or the communication device.

10. The communication control apparatus according to claim 1, wherein the communication station is a relay station that relays communication between a base station and the communication device.

11. The communication control apparatus according to claim 10, wherein the relay station is an integrated access and backhaul (IAB) node including a mobile termination (MT) that functions as a communication device with respect to the base station and a distributed unit (DU) that functions as a base station with respect to the communication device.

12. The communication control apparatus according to claim 10, wherein the base station is a non-terrestrial base station that flies.

13. The communication control apparatus according to claim 12, wherein the non-terrestrial base station is a communication satellite that flies in space.

14. A communication control method comprising executing, by at least one processor:
acquisition of emergency information regarding an emergency information distribution area where at least either a communication station capable of communicating with a communication device or the communication device is located;
generation of local warning information regarding the emergency information in a vicinity of at least either the communication station or the communication device, the vicinity being smaller than the emergency information distribution area; and
distribution of the local warning information from the communication station to the communication device.

15. A storage medium that stores a communication control program of causing at least one processor to execute:
acquisition of emergency information regarding an emergency information distribution area where at least either a communication station capable of communicating with a communication device or the communication device is located;
generation of local warning information regarding the emergency information in a vicinity of at least either the communication station or the communication device, the vicinity being smaller than the emergency information distribution area; and
distribute the local warning information from the communication station to the communication device.
